(19) United States
(12) Patent Application Publication
(10) Pub. No.: US 2014/0319214 A1
(43) Pub. Date: Oct. 30, 2014

(54) Simple CoinCard System

(71) Applicant: David Neal Frayne, Yorktown Heights, NY (US)

(72) Inventor: David Neal Frayne, Yorktown Heights, NY (US)

(21) Appl. No.: 13/763,779

(22) Filed: Apr. 30, 2013

(51) Int. Cl. G06Q 20/34; G06K 19/06

(52) U.S. Cl. CPC G06Q 20/349; G06K 19/06187
USPC 235/381; 235/493

(57) ABSTRACT

The CoinCard System described in this patent application is designed to replace coins associated with retail cash transactions as well as stand-alone vending machines. The System is comprised of software and hardware components that function together as a system. CoinCards used in the System are issued by the appropriate federal agency with both visual and encoded information to assure authenticity and have an initial value of one dollar (in the U.S.). CoinCards would be distributed to banks and then to retailers and vending machine operators for use with equipment supported by the System. A computer program is included to demonstrate the processing involved in various usage scenarios. Benefits include reduced costs to the federal government, banks and retailers.

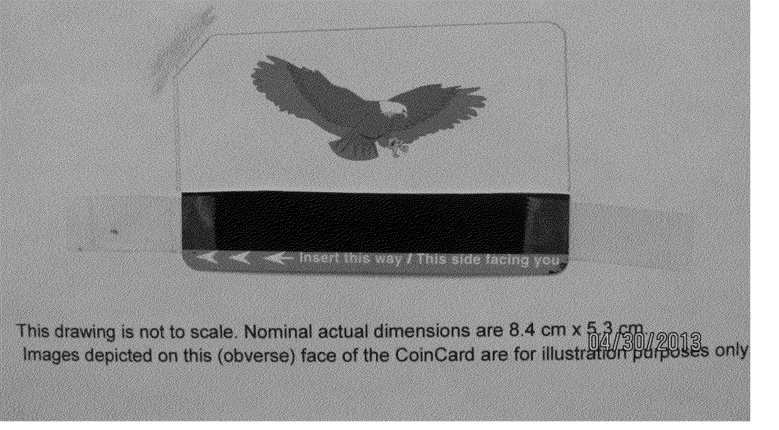

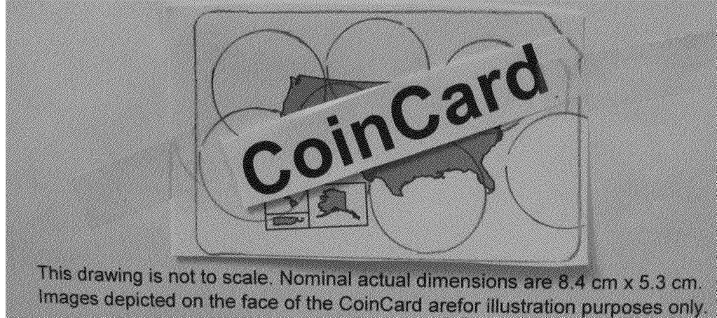

### CROSS REFERENCE TO RELATED APPLICATIONS

n/a

### STATEMENT OF FEDERALLY SPONSORED RESEARCH/DEVELOPMENT

n/a

### REFERENCE TO MICROFICHE APPENDIX

n/a

### BACKGROUND

As coinage becomes more expensive for governments to produce and more burdensome for merchants to support, a simple means for replacing metal coins for cash sales is provided with this CoinCard System.

### BRIEF SUMMARY OF THE COINCARD SYSTEM

This patent application describes a system that is based on currently available technology found in the MetroCard used by the New York Metropolitan Transportation Authority. With the CoinCard, users would purchase a CoinCard at a suitably equipped point-of-sale device. There is no “security” or user identification required for purchase or use of the CoinCard, very much like the coinage that it replaces. CoinCard purchases could also be made with the exchange of a dollar bill.

CoinCards would be produced by the appropriate federal authority, preserving and even enhancing seigniorage associated with today's metal coinage. Once filled with “change”, the CoinCard would be used as described in the typical transactions outlined in the Detailed Description section.

The CoinCard would be of inexpensive material and have an encoded magnetic stripe, in size much like the current MetroCard, which is easily carried in one's wallet or purse. To further identify the CoinCard, images of the coinage would be imprinted on the face of the card, unique to the country of its issuance and to readily identify the card. The federal issuing agency would encode their appropriate identity on the CoinCard's magnetic stripe. Such images and encoding would serve to validate the CoinCard as official, federally accepted currency. The issuing agency would encode an initial value of $1.00 (in the United States) and “sell” the cards through its normal outlets. With such low value and identifying techniques the incentive for forgery and/or counterfeiting would be minimal.

The CoinCard would be used at point-of-sale devices like those found in many retail establishments, but with a CoinCard reader/encoder/dispenser attached. Cash paying customers would simply supply their CoinCard as a first step in paying for their purchase, eliminating the “change” portion of their bill, paying the balance with paper currency and receiving any change in such currency. CoinCards could also be used in machines that vend small items such as candy, soda, coffee or sundries as described in the Transaction Process section that follows.

The CoinCard System is comprised of both hardware and software components that function together as a system, or process.

Typical transactions are described in the Detailed Description that follows.

### BRIEF DESCRIPTION OF THE SEVERAL VIEWS OF THE DRAWING

There are two drawings included with this application. The first drawing is of the front side of the CoinCard. The suggested size of the CoinCard 8.4 cm×5.3 cm. The drawings are not to Scale. The images depicted on the CoinCard are for illustrative purposes only. Actual images would be the purview of the issuing federal agency.

The second drawing is of the opposite side of the CoinCard This (obverse) side depicts the magnetic stripe used for encoding purposes.

### DETAILED DESCRIPTION

Details of various retail cash transactions include but are not limited to the following:

1. A Purchase with No CoinCard
a) With Some Change Due: the purchaser supplies bills to cover the purchase and receives a CoinCard with the appropriate change balance.
   Example: The total purchase is $10.50. The customer supplies $11.00 and receives a CoinCard with a value of 50 cents. The merchant receives a credit of 50 cents, the difference between the initial cost of the CoinCard and the change due the customer.

2. A Purchase with a CoinCard and the CoinCard has
a) Sufficient Value to Cover the Change Due: deduct the change due from the CoinCard balance and update the CoinCard with the new value, if any.
   Example: CoinCard value is 50 cents and the change due is 40 cents, the new CoinCard value would be 10 cents.
b) Insufficient Value on the CoinCard to Cover the Change Due: add a whole dollar amount to the customer's bill and update the CoinCard with the difference.
   Example: CoinCard value is 50 cents and the change due is 60 cents, the new CoinCard value would be 90 cents. If, for example, the customer's total bill was $10.60 the customer would tender a total of $11.50, $11.00 (in bills)+0.50 (CoinCard) and receive the CoinCard back with a value of 90 cents.

3. Purchases When a Customer Wishes to Use More Than one CoinCard
The customer supplies the CoinCards and requisite paper bills and receives any change on one CoinCard.
   Example 1: The customer's bill is $35.75 and tenders $40.00 in paper currency and two CoinCards with a combined value of 75 cents. The customer receives change entirely in paper currency of $5 dollars.
   Example 2: The customer's bill is $35.75 and tenders $40.00 in paper currency and two CoinCards with a combined value of 50 cents. The customer receives $4 back in bills and 25 cents on one CoinCard.

4. A Purchase at a Vending Machine with CoinCard Capabilities
When the item is not of a whole dollar amount the purchaser tends the requisite paper bill(s) and receives one or more CoinCard(s) encoded with his/her “change”.
   Example: The purchaser tenders $2 for an item costing $1.50 and receives a CoinCard(s) as change with a value of 50 cents

A brief logic flow and a more detailed computer program follow. The program both demonstrates the feasibility of the CoinCard System and provides the basis for implementation in a production environment.

Abbreviations used in the logic flow for the point-of-sale transactions described above:
CC CoinCard
CCRDR CoinCard reader/encoder/dispenser
POSD Point of sale device
CCVAL CoinCard value

Logic Flow:

CC supplied?

No ====> do math per Detailed Description 1.a above

Issue new CC
Continue to checkout

Yes ====> does CC have sufficient value to cover change due?

Yes ====> do math as per 2.a above

Dispense CC with updated value
Continue to checkout

No =====> do math as per 2.b above

Dispense CC with updated value
Continue to checkout

1. Hardware components
1. Coinage on a magnetically encoded card for purposes of retail cash purchases
2. A CoinCard reader/encoder/dispenser attached to a point-of-sale device (e.g., a cash register or a self-checkout terminal)
3. A CoinCard dispenser integral to and replacing metal coinage devices at vending machines
Software Component
Specific processing details for the use of the CoinCard in cash transactions, including the following:
4. no CoinCard
5. CoinCard with sufficient value for the transaction
6. CoinCard with insufficient value for the transaction
7. Use of multiple CoinCards with one transaction
8. CoinCards as change at vending machines
Potential Benefits Associated with Claims
Reduced cost to the government associated with metal coin production and distribution
Reduced cost to banks for stocking, distribution and collection associated with metal coins
Reduced cost for merchants for metal coin counting, packaging for return to banks, and speedier checkout for cash paying customers
Simpler and less expensive maintenance of self checkout and vending machines by eliminating mechanical devices associated with metal coins
And, by reducing the need for customers to carry coins.
